(19) United States
(12) Patent Application Publication
(10) Pub. No.: US 2026/0136139 A1
(43) Pub. Date: May 14, 2026

(54) MEMS speaker

(71) Applicant: AAC Kaitai Technologies (Wuhan) CO., LTD., Wuhan (CN)

(72) Inventors: Qiang Dan, Wuhan (CN); Yiwei Zhou, Wuhan (CN); Yu Shen, Wuhan (CN); Yang Li, Wuhan (CN)

(21) Appl. No.: 19/437,381

(22) Filed: Dec. 31, 2025

Related U.S. Application Data
(63) Continuation of application No. 17/879,757, filed on Aug. 2, 2022, now abandoned.

(30) Foreign Application Priority Data
Mar. 3, 2022 (CN) 202220454568.0

(51) Int. Cl. H04R 19/02; H04R 1/02

(52) U.S. Cl. CPC H04R 19/02; H04R 1/023; H04R 2201/003

(57) ABSTRACT

The present disclosure discloses a MEMS speaker including a substrate with a cavity and a sounding assembly connected with the substrate, the substrate comprising an outer surface away from the cavity and connected with the sounding assembly, a top surface opposite to the outer surface and a side surface respectively connected with the outer surface and the top surface; a printed circuit board with a through hole and connected with the outer surface of the substrate; a first shell connected with the top surface of the substrate; and a damping mesh covering the through hole and connected with the printed circuit board; wherein sounds emitted by the sounding assembly transmit outward through the through hole and the damping mesh. Compared with the related art, MEMS speaker disclosed by the present disclosure has a better reliability.

### CROSS REFERENCE TO RELATED APPLICATIONS

The present application is a continuation of U.S. Application No. 17879757, filed on Aug. 02, 2022, which claims priority to Chinese patent application No. 202220454568.0, filed Mar. 03, 2022, all of the aforementioned patent applications are incorporated by reference herein in their entirety.

### FIELD OF THE PRESENT DISCLOSURE

The present disclosure relates to a field of sound-electric conversion technology, in particular to a micro-electro-mechanical system (MEMS) speaker.

### DESCRIPTION OF RELATED ART

As one of the main components of mobile terminals such as mobile phones, speakers mainly convert electrical signals into sound signals.

MEMS speakers (Micro-Electro-Mechanical System) what is micro-electromechanical system speakers, have the advantages of better consistency, lower power consumption, smaller size, and lower price compared to traditional voice coil speakers. A MEMS speaker in related art includes a printed circuit board, a casing connected with the printed circuit board for forming an accommodation space, and a MEMS speaker chip located in the accommodation space, the casing includes a sound hole. However, the total harmonic distortion of the MEMS speaker chip increases when it vibrates to make sound, which greatly affects the performance of the MEMS speaker.

Thus, it is necessary to provide a MEMS speaker to solve the problem.

### SUMMARY OF THE DISCLOSURE

A MEMS speaker disclosed in the present disclosure including a substrate with a cavity and a sounding assembly connected with the substrate, the substrate comprising an outer surface away from the cavity and connected with the sounding assembly, a top surface opposite to the outer surface and a side surface respectively connected with the outer surface and the top surface; a printed circuit board with a through hole and connected with the outer surface of the substrate; a first shell connected with the top surface of the substrate; and a damping mesh covering the through hole and connected with the printed circuit board; wherein sounds emitted by the sounding assembly transmit outward through the through hole and the damping mesh.

Further, an acoustic impedance value of the damping mesh is in a range of 1 Mrayl - 500 Mrayl.

Further, the first shell includes a communication hole communicating with the cavity, the MEMS speaker further includes a dust mesh covering the communication hole.

A MEMS speaker disclosed in the present disclosure including a MEMS speaker chip, comprising a substrate with a cavity and a sounding assembly connected with the substrate, the substrate comprising an outer surface away from the cavity and connected with the sounding assembly, a top surface opposite to the outer surface and a side surface respectively connected with the outer surface and the top surface; a printed circuit board with a through hole and connected with the outer surface of the substrate; a first shell with a sound hole communicating with cavity, connected with the top surface of the substrate; and a second shell connected with the printed circuit board and covering the through hole; and a damping mesh covering the sound hole; wherein sounds emitted by the sounding assembly transmit outward through the sound hole and the damping mesh.

Further, an acoustic impedance value of the damping mesh is in a range of 1 Mrayl - 500 Mrayl.

Further, the first shell includes a bottom wall spaced from the top surface of the substrate and a side wall located between the top surface and the bottom wall, the side wall is respectively connected with the top surface and the bottom wall, the sound hole is provided on the side wall, the damping mesh covers the sound hole.

Further, the second shell includes a communication hole communicating with the through hole, the MEMS speaker further includes a dust mesh covering the communication hole.

A MEMS speaker disclosed in the present disclosure including a MEMS speaker chip, comprising a substrate with a cavity and a sounding assembly connected with the substrate, the substrate comprising an outer surface away from the cavity and connected with the sounding assembly, a top surface opposite to the outer surface and a side surface respectively connected with the outer surface and the top surface; a printed circuit board with a through hole, connected with the outer surface of the substrate; a first shell connected with the top surface of the substrate; and a second shell with a sound hole communicating with the through hole, connected with the printed circuit board and covering the through hole; and a damping mesh covering the sound hole; wherein sounds emitted by the sounding assembly transmit outward through the sound hole and the damping mesh.

Further, an acoustic impedance value of the damping mesh is in a range of 1 Mrayl - 500 Mrayl.

Further, the second shell includes a bottom wall spaced from the printed circuit board of the substrate and a side wall located between the printed circuit board and the bottom wall, the side wall is respectively connected with the printed circuit board and bottom wall, the sound hole is provided on the side wall, the damping mesh covers the sound hole.

Further, the fixing portion includes a second surface opposite to the first surface, the second surface comprises a second arc surface extending to the substrate.

Further, the fixing portion includes a second surface opposite to the first surface, the second surface comprises a second arc surface connected to the connecting portion and a connecting surface connecting the second arc surface and the substrate, the connecting surface is perpendicular to the substrate.

Further, the fixing portion includes a second surface opposite to the first surface, the second surface comprises a second arc surface connected to the connecting portion and a connecting surface connecting the second arc surface and the substrate, the connecting surface is a circular arc surface.

Further, the first surface includes a third arc surface connected to the first arc surface and the fixing portion, the third arc surface protrudes toward the direction away from the substrate.

Further, a junction of the first arc surface and the third arc surface is closer to the substrate than the body part.

Further, the third arc surface is a circular arc surface.

Further, the first arc surface is a circular arc surface.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is a cross-sectional view of the MEMS speaker provided in a first embodiment;

FIG. 2 is a sound pressure level SPL of the comparative test data according to the MEMS speaker in the first embodiment and the MEMS speaker in related art;

FIG. 3 is a total resonance distortion THD of the comparative test data according to the MEMS speaker in the first embodiment and the MEMS speaker in related art;

FIG. 4 is a cross-sectional view of the MEMS speaker provided in a second embodiment;

FIG. 5 is a cross-sectional view of the MEMS speaker provided in a third embodiment.

### DETAILED DESCRIPTION OF THE EXEMPLARY EMBODIMENTS

The present disclosure will hereinafter be described in detail with reference to exemplary embodiments. To make the technical problems to be solved, and technical solutions and beneficial effects of the present disclosure more apparent, the present disclosure is described in further detail together with the figure and the embodiment. It should be understood the specific embodiment described hereby is only to explain the disclosure, not intended to limit the disclosure.

### First Embodiment

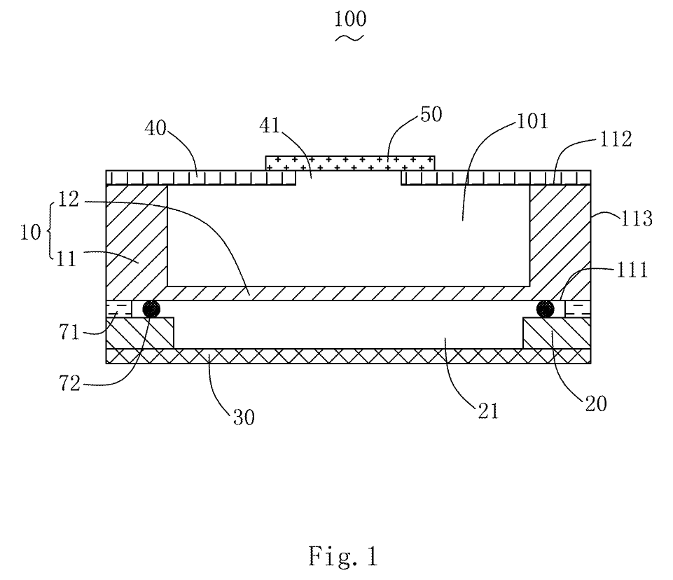

Referring to FIG. 1, this embodiment provides a MEMS speaker 100, including a MEMS speaker chip 10, the MEMS speaker chip 10 includes a substrate 11 with a cavity 101 and a sounding assembly 12 connected with the substrate 11. The substrate 11 includes an outer surface 111 away from the cavity 101, a top surface 112 opposite to the outer surface 111, and a side surface 113 connected with the top surface 112 and the outer surface 111. The outer surface 111 is connected with the sounding assembly 12. The MEMS speaker 100 further includes a printed circuit board 20 connected with the outer surface 111 of the substrate 11. In this embodiment, the printed circuit board is connected with the outer surface 111 via solders 71 and glues 72. The printed circuit board 20 is provided with a through hole 21, an orthographic projection of the sounding assembly 12 is all located in the through hole 21. Thus, the through hole 21 provides a vibration space for the sounding assembly 12.

The MEMS speaker further includes a damping mesh 30 attached to the printed circuit board 20, the damping mesh 30 covers the through hole 21. The damping mesh 30, the printed circuit board 20 and the sounding assembly 12 form a front cavity, and the sounds emitted by the sounding assembly 12 are transmitted to the outside through the through hole 21 and the damping mesh 30. Therefore, the quality factor Q value of the MEMS speaker 100 can be effectively adjusted via the damping mesh 30, the resonance caused by the front cavity can be reduced, and the total harmonic distortion can be improved, thereby the performance of the MEMS speaker 100 could be improved. Preferably, an acoustic impedance value of the damping mesh 30 is in a range of 1 Mrayl - 500 Mrayl. The damping mesh 30 completely covers the through hole 21.

FIG. 2 is a sound pressure level SPL of the comparative test data according to the MEMS speaker in this embodiment and the MEMS speaker in related art. The related MEMS speaker is not provided with a damping mesh, and its SPL curve is the A curve, the SPL curve of the present application is the B curve. The following conclusion can be drawn: the provision of the damping mesh 30 can suppress the SPL resonance peak caused by the front cavity.

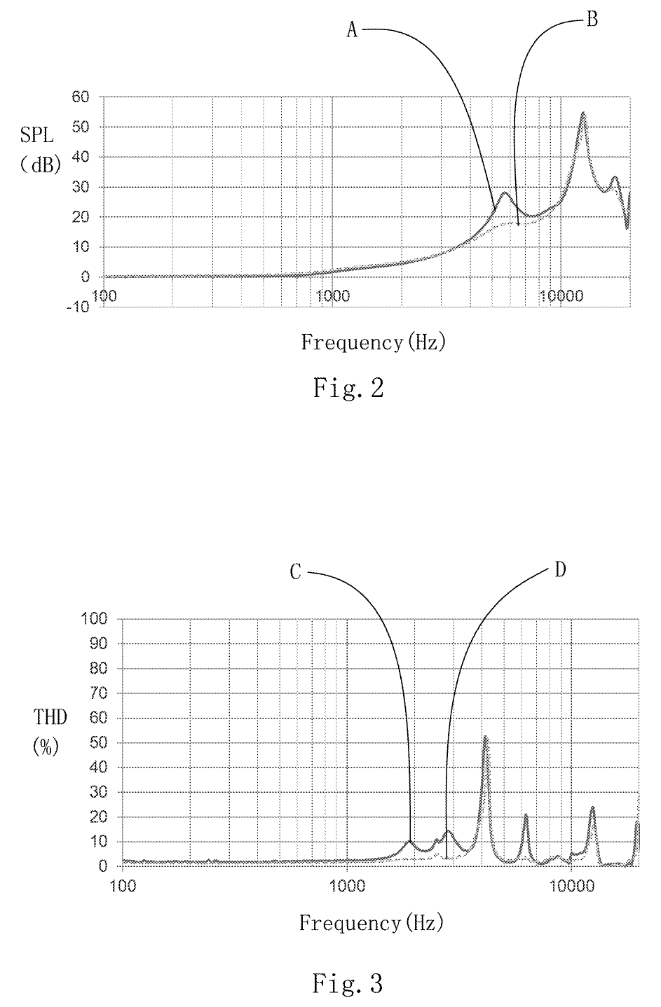

FIG. 3 is s a total resonance distortion THD of the comparative test data according to the MEMS speaker in this embodiment and the MEMS speaker in related art. The related MEMS speaker is not provided with a damping mesh, and its THD curve is the C curve, the THD curve of the present application is the D curve. The following conclusion can be drawn: the provision of the damping mesh 30 can suppress the THD resonance peak caused by the front cavity.

In addition, the MEMS speaker 100 further includes a first shell 40 connected with the top surface 112 of the substrate 11, the first shell 40 is in a flat shape and covers the cavity 101. In this embodiment, the cavity 101 of the MEMS speaker chip 10 is a rear cavity, the first shell 40 can completely seal the cavity 101 or be provided with a communication hole 41 communicating with the cavity 101, and a dust mesh 50 covers the communication hole 41, the dust mesh 50 is attached to an outer surface of the first shell 40. The communication hole 41 can increase the volume of the rear cavity and improve the low frequency effect of the MEMS speaker 100.

In this embodiment, a package structure is directly formed by stacking the first shell 40, the MEMS speaker chip 10 and the printed circuit board 20, which saves space and reduces the volume of the MEMS speaker 100.

### Second Embodiment

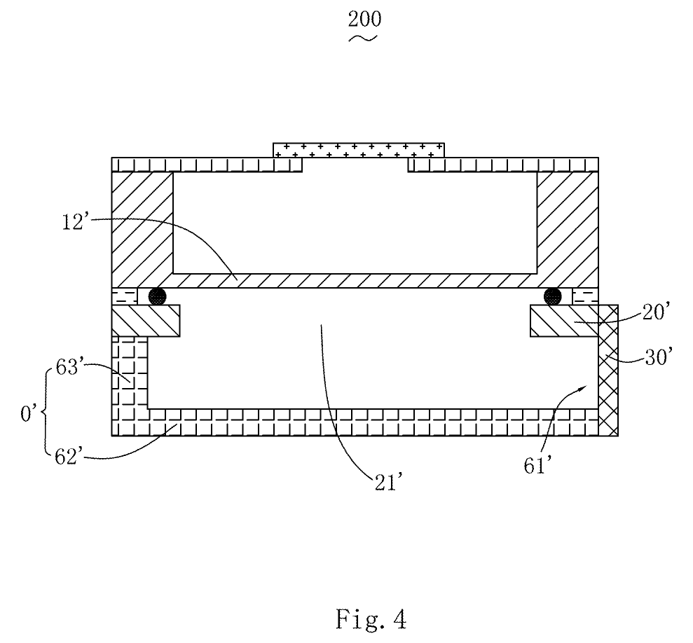

Referring to FIG. 4, a MEMS speaker 200 is provided by the second embodiment. The distinction between the second embodiment and the first embodiment is that, the MEMS speaker 200 further includes a second shell 60’ connected with the printed circuit board 20’. The second shell 60’ includes a bottom wall 62’ spaced from the printed circuit board 20’ and a side wall 63’ located between the printed circuit board 20’ and the bottom wall 62’, the side wall 63’ is respectively connected with the printed circuit board 20’ and the bottom wall 62’, the side wall 63’ is provided with a sound hole 61’, the damping mesh 30’ covers the sound hole 61’. In this embodiment, the sound hole 61’ runs through the side wall 63’, in other words, two ends of the damping mesh 30’ are respectively connected with the printed circuit board 20’ and the bottom wall 62’. Therefore, the sounds emitted by the sounding assembly 12’ are transmitted to the outside through the through hole 21’, the sound hole 61’ and the damping mesh 30. Thus, the sounds emitted by the sounding assembly 12’ could be transmitted from the bottom of the MEMS speaker 200.

### Third Embodiment

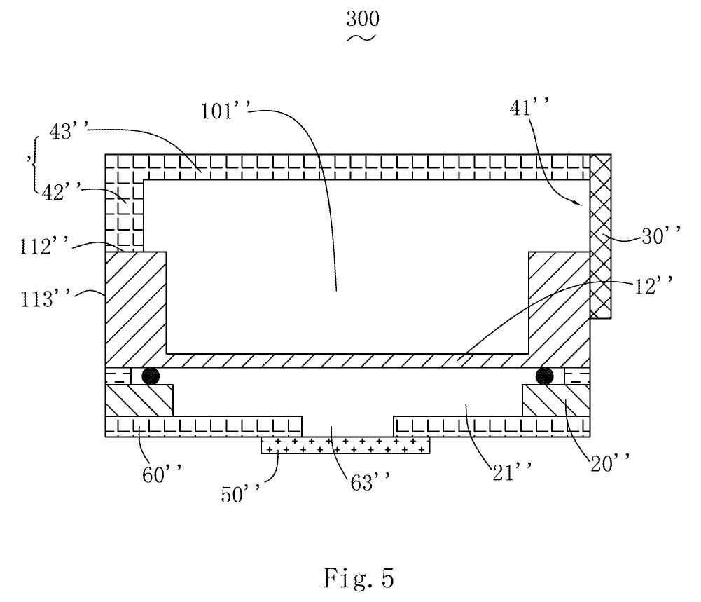

Referring to FIG. 5, a MEMS speaker 300 is provided by the third embodiment. The distinction between the third embodiment and the first embodiment is that, the shape of the first shell 40’’ and the second shell 60’’ are different. Further, the first shell 40’’ includes a bottom wall 43’’ spaced from the top surface 112’’ and a side wall 42’’ located between the top surface 112’’ and the bottom wall 43’, the side wall 42’’ is respectively connected with the top surface 112’’ and the bottom wall 43’’, the side wall 42’’ is provided with a sound hole 41’’, the damping mesh 30’’ covers the sound hole 41’’. In this embodiment, the sound hole 41’’ runs through the side wall 42’’, in other words, two ends of the damping mesh 30’’ are respectively connected with the side surface 113’’ and the bottom wall 43’’. Therefore, the sounds emitted by the sounding assembly 12’’ are transmitted to the outside through the cavity 101’’, the sound hole 41’’ and the damping mesh 30’’. Thus, the sounds emitted by the sounding assembly 12’’ could be transmitted from the top of the MEMS speaker 300.

In addition, the second shell 60’’ is in a flat shape, the second shell 60’’ is further provided with a communicating hole 63’’ communicating with the through hole 21’’, the MEMS speaker further includes a dust mesh 50’’ covering the communicating hole 63’’.

It is to be understood, however, that even though numerous characteristics and advantages of the present exemplary embodiment have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A MEMS speaker, comprising:
a MEMS speaker chip, comprising a substrate with a cavity and a sounding assembly connected with the substrate, the substrate comprising an outer surface away from the cavity and connected with the sounding assembly, a top surface opposite to the outer surface and a side surface respectively connected with the outer surface and the top surface;
a printed circuit board with a through hole and connected with the outer surface of the substrate;
a housing comprising a first shell and a second shell that are separately disposed on both sides of the sounding assembly along a thickness direction of the sounding assembly, the first shell covering the cavity and being connected to the top surface, the second shell covering the through hole and being connected to the printed circuit board, a sound hole being provided on a side wall of the housing, and the side wall being disposed on a side of the MEMS speaker;
a damping mesh covering the sound hole; wherein
sounds emitted by the sounding assembly transmit outward through the sound hole and the damping mesh.

2. The MEMS speaker as described in claim 1, wherein the first shell comprises a first bottom wall spaced from the top surface of the substrate and a first side wall located between the top surface and the first bottom wall, the first side wall is respectively connected with the top surface and the first bottom wall, the sound hole is provided on the first side wall, and the damping mesh covers the sound hole; and
wherein the sounds emitted by the sounding assembly are transmitted outward through the cavity, the sound hole and the damping mesh.

3. The MEMS speaker as described in claim 2, wherein two ends of the damping mesh are respectively connected with the side surface and the first bottom wall.

4. The MEMS speaker as described in claim 2, wherein the second shell is in a flat shape.

5. The MEMS speaker as described in claim 4, wherein the second shell comprises a communication hole communicating with the through hole, the MEMS speaker further includes a dust mesh covering the communication hole.

6. The MEMS speaker as described in claim 1, wherein the second shell comprises a second bottom wall spaced from the printed circuit board of the substrate and a second side wall located between the printed circuit board and the second bottom wall, the second side wall is respectively connected with the printed circuit board and the second bottom wall, the sound hole is provided on the second side wall, and the damping mesh covers the sound hole; and
wherein the sounds emitted by the sounding assembly are transmitted outward through the through hole, the sound hole and the damping mesh.

7. The MEMS speaker as described in claim 6, wherein two ends of the damping mesh are respectively connected with the printed circuit board and the second bottom wall.

8. The MEMS speaker as described in claim 6, wherein the first shell is in a flat shape.

9. The MEMS speaker as described in claim 8, wherein the first shell comprises a communication hole communicating with the cavity, the MEMS speaker further includes a dust mesh covering the communication hole.

10. The MEMS speaker as described in claim 1, wherein the side wall is parallel to the side surface.

11. The MEMS speaker as described in claim 1, wherein an acoustic impedance value of the damping mesh is in a range of 1 Mrayl - 500 Mrayl.
